(19) United States
(12) Patent Application Publication
(10) Pub. No.: US 2017/0103175 A1
(43) Pub. Date: Apr. 13, 2017

(54) SYSTEM AND METHOD FOR MANAGING MEDICAL ALERTS

(71) Applicant: PINGMD, INC., New York, NY (US)

(72) Inventors: Gopal Chopra, New York, NY (US); Manju Chopra, New York, NY (US); Mohammad Tahir Khan, Ossining, NY (US)

(21) Appl. No.: 14/879,660

(22) Filed: Oct. 9, 2015

(51) Int. Cl. G06F 19/00

(52) U.S. Cl. CPC G06F 19/3406; G06F 19/322

(57) ABSTRACT

Described herein are systems and methods for managing medical alerts. In one embodiment, a method includes receiving a medical alert notification and user-generated content from a device of a patient. A message comprising the user-generated content and biometric data associated with the patient is generated and transmitted to a device associated with a care team of the patient.

### FIELD OF THE INVENTION

Embodiments of the invention relate generally to the field of patient care management, and more specifically, to monitoring biometric data of patients and the generation and management of medical alerts.

### BACKGROUND

Consumers of healthcare can find it difficult to communicate medical issues with their care team in many situations. Healthcare providers often require additional information that telephonic services cannot provide, including pictures, video, and relevant health data (both current and historic), with inefficient data delivery and search systems (in both paper and electronic form) placing additional burdens on doctors. There is often a lack of prioritization of work inflow in the practice and inappropriate triaging of clinical issues. Moreover, healthcare today lacks systems for effectively evaluating or measuring patient compliance to health management protocols. Such issues can be potentially hazardous to a patient in scenarios in which the patient is attempting to notify his/her care team of a medical emergency or a potential medical emergency.

### BRIEF DESCRIPTION OF THE DRAWINGS

The embodiments of the present disclosure are illustrated by way of example, and not by way of limitation, and will become apparent upon consideration of the following description of the invention, taken in conjunction with the accompanying drawings, in which:

FIG. 1 illustrates an example system architecture in which embodiments of the present disclosure may operate;

FIG. 2 is a block diagram illustrating a patient management component and data architecture in accordance with an embodiment of the present disclosure;

FIG. 3 is a flow diagram illustrating a method for determining which type of user interface is to be presented on a client device in accordance with an embodiment of the disclosure;

FIG. 4 is a flow diagram illustrating a method for managing a medical alert in accordance with an embodiment of the disclosure;

FIG. 5A illustrates an exemplary graphical user interface representing a high-risk interface in accordance with an embodiment of the present disclosure;

FIG. 5B illustrates an exemplary graphical user interface representing a high-risk interface in accordance with an embodiment of the present disclosure;

FIG. 6A illustrates an exemplary graphical user interface for capturing a voice message in accordance with an embodiment of the disclosure;

FIG. 6B illustrates an exemplary graphical user interface for sending a voice message to a care team in accordance with an embodiment of the disclosure;

FIG. 7 illustrates an exemplary graphical user interface presented on a device of a member of a care team in accordance with an embodiment of the disclosure;

FIG. 8 is a flow diagram illustrating a method for transmitting messages to multiple entities in accordance with an embodiment of the disclosure;

FIG. 9 is a flow diagram illustrating a method for selectively monitoring biometric data of a patient in accordance with an embodiment of the disclosure; and

FIG. 10 is a block diagram illustrating an exemplary computer system in accordance with an embodiment of the disclosure.

### DETAILED DESCRIPTION

The embodiments of the present disclosure relate to a system and method for generating and managing medical alerts. A patient may be able to alert his/her doctor in the event of a medical emergency using a personal device. In generating an alert, the patient may wish to include content such as images, videos, voice messages, or combinations thereof. The alert and content are then transmitted to a medical server, which generates alert messages (e.g., in the form of e-mails, Short Message Service (SMS) messages, instant messages, automated phone calls, etc.) for dispatching to the patient's care team any friends or family that would benefit from being notified. If the patient is wearing a monitoring device that captures the patient's biometric data, the medical server may also identify biometric data that are relevant to the alert and transmit this information along with the alert message.

Thus, the embodiments of the present disclosure provide several advantages, including (1) the ability to monitor a patient's biometric data in real-time, (2) improved communication between the patient and his/her care team, especially in high-risk scenarios, (3) an easy-to-use interface for both the patient and care team, (4), improved patient data reporting for simplifying the care team's analysis, and (5) the ability to control which parties receive medical alerts and what information those parties have access to.

As used herein, the term “patient” refers to any individual who is receiving medical services from a provider of healthcare services (“healthcare provider”). The term “patient” may also refer to a custodian who is responsible for an individual receiving the healthcare services (e.g., a patient, in this context, may refer to a parent of a child receiving healthcare services when the child is unable to communicate effectively with his/her doctor).

Also as used herein, the term “care team” refers to any group of individuals affiliated with a healthcare provider that performs medical services for a patient. A care team may include, for example, doctors (clinicians, physicians, surgeons, etc.), nurses, medical technicians, and other medical staff.

Also as used herein, the term “caretaker” refers to any individual or group of individuals that are unaffiliated with a patient's healthcare provider but act in a non-custodial supportive capacity toward the patient. A caretaker may include, for example, a family member, friend, or professional caretaker.

Also as used herein, the term “biometric data” refers to any data related to physiological parameter or quantity measureable for an individual, such as, but not limited to, heart rate, blood pressure, respiratory rate, body temperature, body composition (e.g., body mass index, percent body fat, hydration level, etc.), cholesterol, hemoglobin levels, blood glucose levels, or triglycerides. Biometric data may be acquired using any standard instrumentation for measuring physiological parameters or quantities, including wearable devices worn by the individual (e.g., subdermal or transdermal devices). As used herein, the term “monitoring device” broadly refers to any such device capable of acquiring and monitoring biometric data.

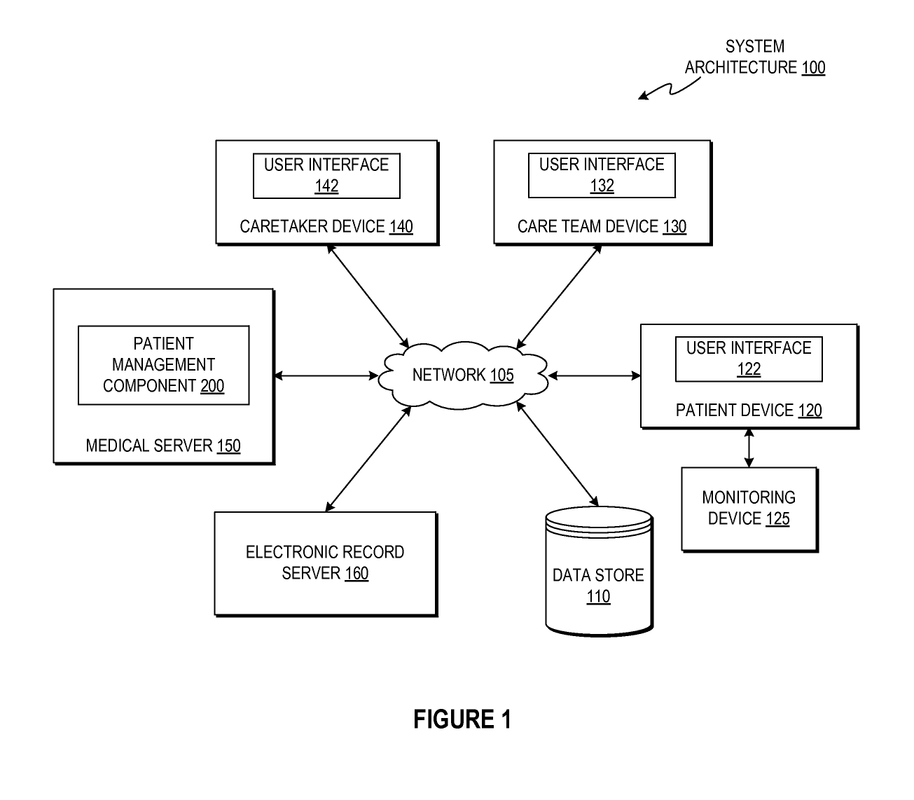

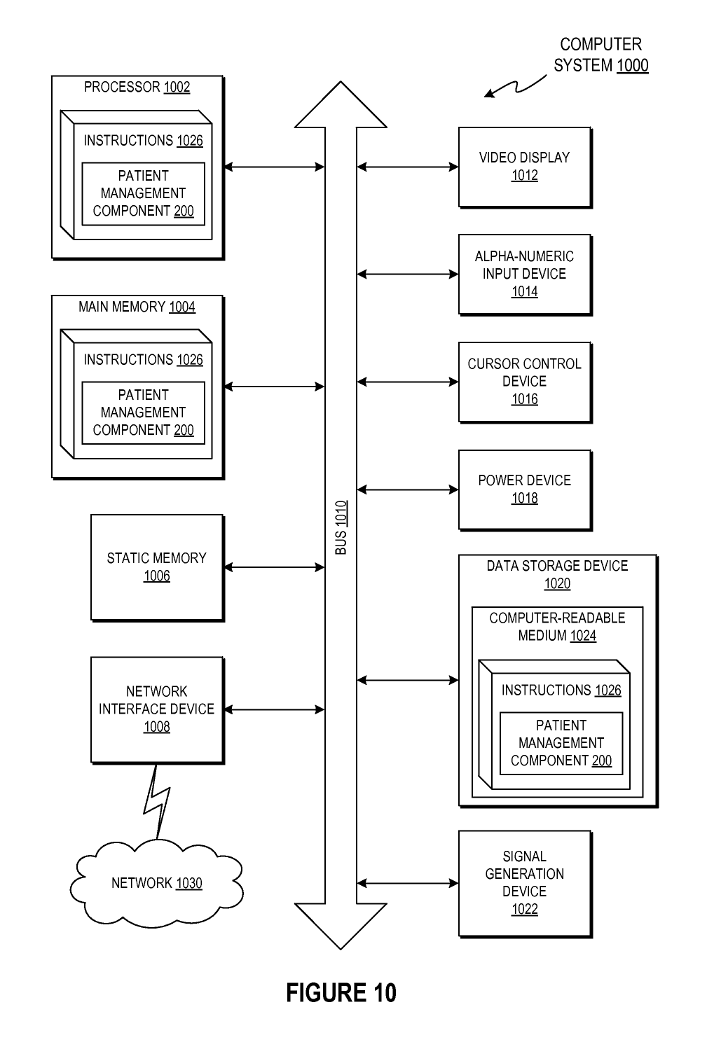

FIG. 1 illustrates an example system architecture 100 architecture in which embodiments of the present disclosure may operate. The system architecture 100 includes a data store 110, a patient device 120, a monitoring device 125, a care team device 130, a caretaker device 140, a medical server 150, and an electronic record server 160, with each device of the system architecture 100 being communicatively coupled via a network 105. One or more of the devices of the system architecture 100 may be implemented, for example, using computer system 1000, described below with respect to FIG. 10.

In one embodiment, the network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 105 is depicted as a single network, the network 105 may include one or more networks operating as stand-alone networks or in cooperation with each other. The network 105 may utilize one or more protocols of one or more devices to which it is communicatively coupled. The network 105 may translate its protocols to one or more protocols of network devices.

In certain embodiments, the data store 110 may be a memory (e.g., random access memory), a cache, a drive (e.g., a hard drive), a flash drive, a database system, or another type of component or device capable of storing data. The data store 110 may also include multiple storage components (e.g., multiple drives or multiple databases) that may also span multiple computing devices (e.g., multiple server computers). In some embodiments, the data store 110 may be cloud-based. One or more of the devices of system architecture 100 may utilize their own storage and/or the data store 110 to store public and/or private data. In embodiments in which private data is to be stored (e.g., patient medical data), the data store 110 is configured to provide secure storage for such data. In some embodiments, the data store 110 is utilized for data back-up or archival purposes.

In certain embodiments, each of the patient device 120, the care team device 130, and the caretaker device 140 may be a computing device such as a personal computer (PC), laptop, a mobile phone, a smart phone, a tablet computer, a netbook computer, a smart TV, etc. Each of the patient device 120, the care team device 130, and the caretaker device 140 may be referred to herein as a “client device”, a “user device”, or a “mobile device”. As used herein, a “user” may be represented as a single individual that is in operational control of the one of the devices of the system architecture 100.

Each of the patient device 120, the care team device 130, and the caretaker device 140 may be associated with (e.g., owned or used by) a particular user (or set of users) having a specific role within the context of healthcare management. For example, a user of the patient device 120 may be a patient who uses the patient device 120 to assist in monitoring his/her biometric data, communicate with members of a care team, generate medical alert notifications, etc. As another example, a user of the care team device 130 may be a member of a care team, such as a clinician, physician, nurse, or any other individual in a clinical role who uses the care team device 130 to perform healthcare management services. Such services may include reviewing patient data, communicating with the patient, communicating with other members of the care team, etc. As another example, a user of the caretaker device 140 may be a friend of the patient, family member of the patient, or other individual in a caretaking or supportive role who uses the caretaker device 140 to communicate with the patient, members of the care team, or other individuals in caretaking or supportive roles. Such communications may be managed in compliance with patient preferences and/or patient confidentiality protocols (e.g., the Health Insurance Portability and Accountability Act, “HIPAA”).

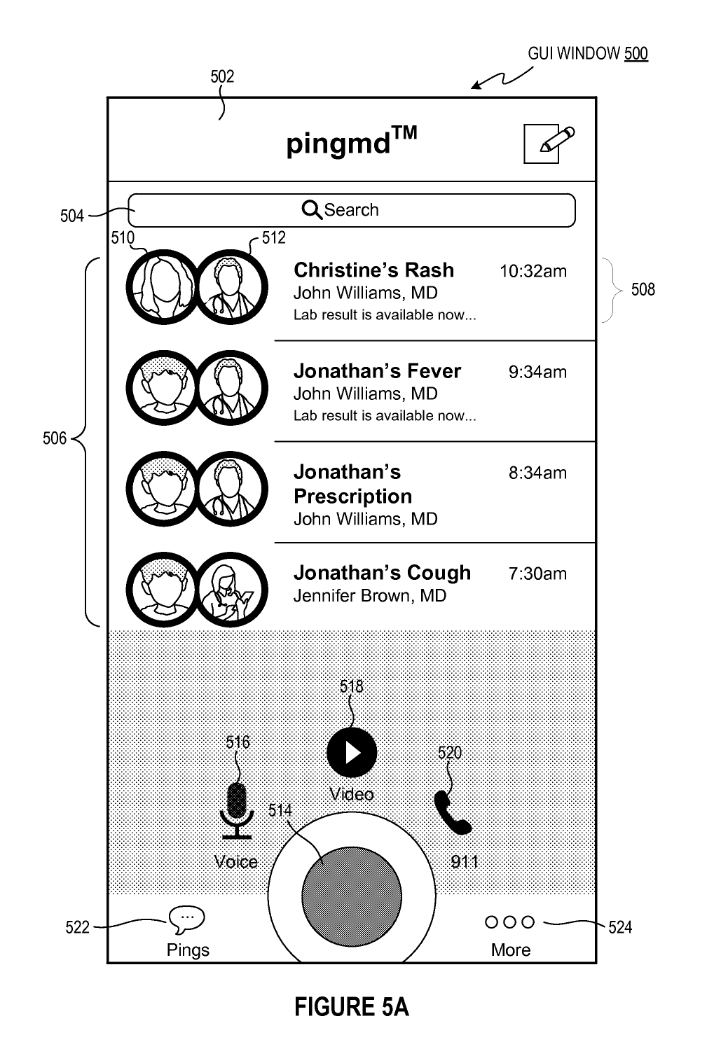

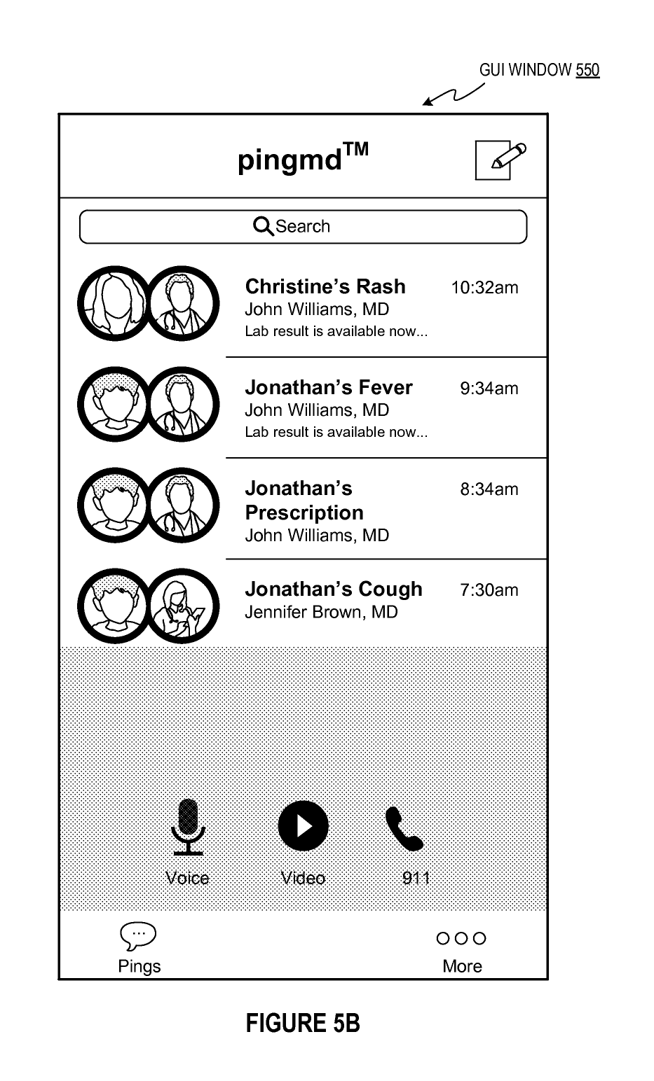

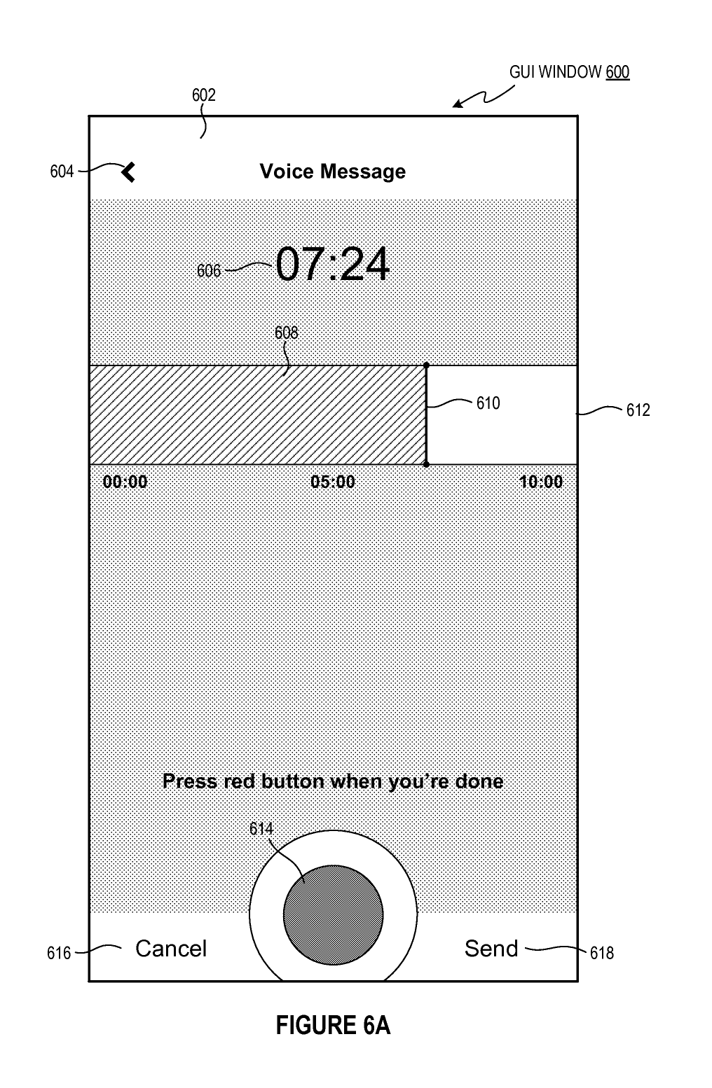

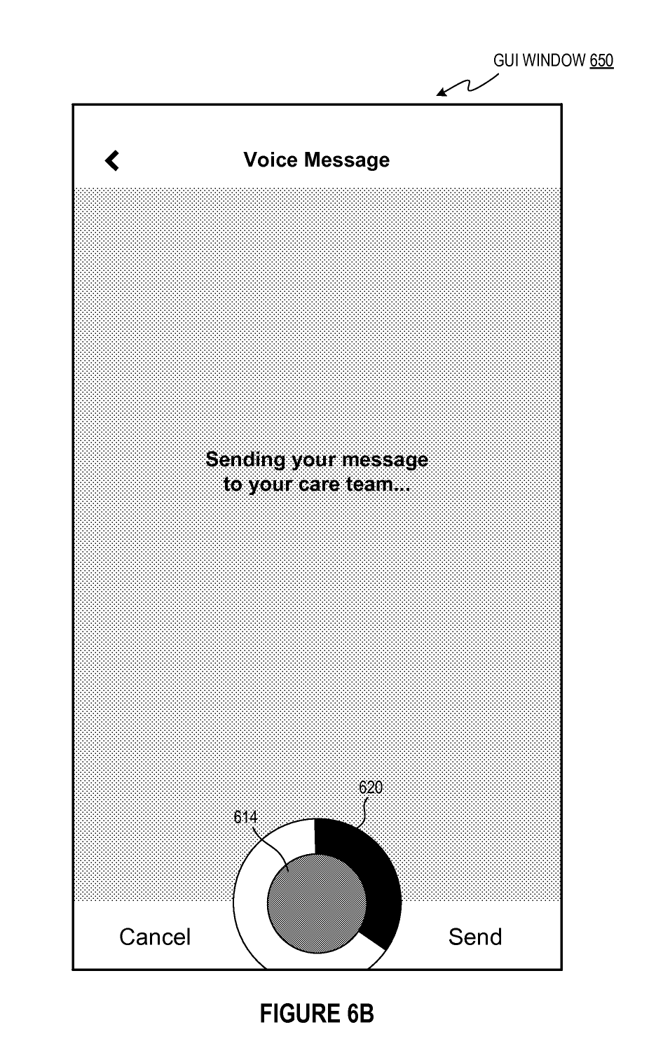

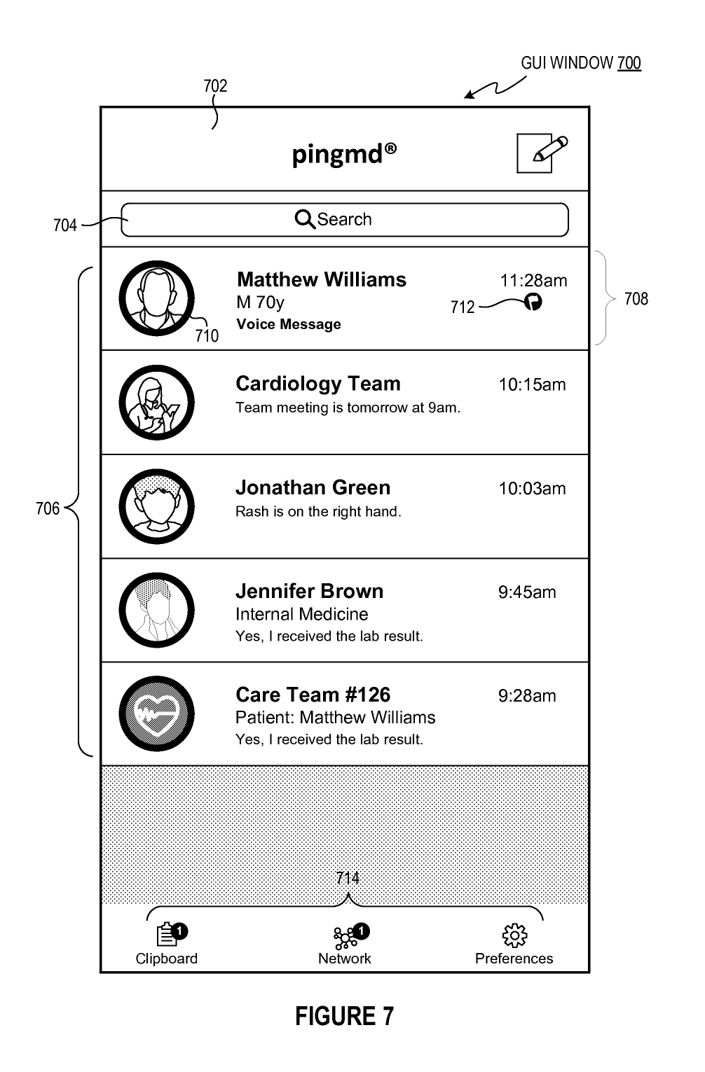

The patient device 120 implements a user interface 122, which may allow the user of the patient device 120 to send/receive information to/from the data store 110, the monitoring device 125, the care team device 130, the caretaker device 140, the medical server 150, the electronic record server 160, or other servers or devices. For example, the user interface 122 may be a web browser interface that can access, retrieve, present, and/or navigate content (e.g., web pages such as Hyper Text Markup Language (HTML) pages). As another example, the user interface 122 may enable data visualization by the patient device 120. In one embodiment, the user interface 122 may be a standalone application (e.g., a mobile “app”, etc.), that allows the user of the patient device 120 to send/receive information to/from any of the devices of the system architecture 100 or other devices. Similarly, the care team device 130 and the caretaker device 140 may also implement user interfaces 132 and 142, respectively, which may be similar to the user interface 122 in functionality. FIGS. 5-6, which are discussed in greater detail below, show examples of user interfaces that may be implemented by the patient device 120. Similarly, FIG. 7 shows an example of a user interface that may be implemented by the care team device 130.

Although represented as individual devices in the system architecture 100 for illustrative purposes, additional patient devices, care team devices, and caretaker devices may be utilized. For example, the system architecture 100 may include additional patient devices each utilized by one or more individual patients (who are each receiving separate healthcare services from the same care team or different care teams). As another example, one or more of the additional devices may be utilized by a single patient.

In certain embodiments, the monitoring device 125 may be a wearable device, such as a subdermal or transdermal device. Examples of wearable devices include, but are not limited to, glucose monitors, blood pressure monitors, electrocardiogram monitors, respiratory monitors, pulse oximeters, and temperature monitors. In certain embodiments, the monitoring device 125 (if it is a wearable device) may include an inertial measurement unit that may be configured to collect gyroscopic data, which may be used to monitor motion of the patient and, in certain embodiments, be used for fall detection. In certain embodiments, the monitoring device 125 may monitor location data by collecting global positioning system (GPS) data. Although a single monitoring device 125 is shown, a patient may at any time be monitored by multiple monitoring devices (which may be wearable or non-wearable) to measure multiple biometric parameters. In certain embodiments, one or more of the monitoring devices may be adapted to measure two or more different biometric parameters (e.g., a wearable device that measures heart rate and breathing rate). In certain embodiments, one or more of the monitoring devices may be under operational control of the patient device 120. In certain embodiments, one or more of the monitoring devices may be coupled to the medical server 150 and transmit their respective data via the network 105, bypassing the patient device 120. In certain embodiments, one or more of the monitoring devices may be combined into or interfaced with the patient device 120.

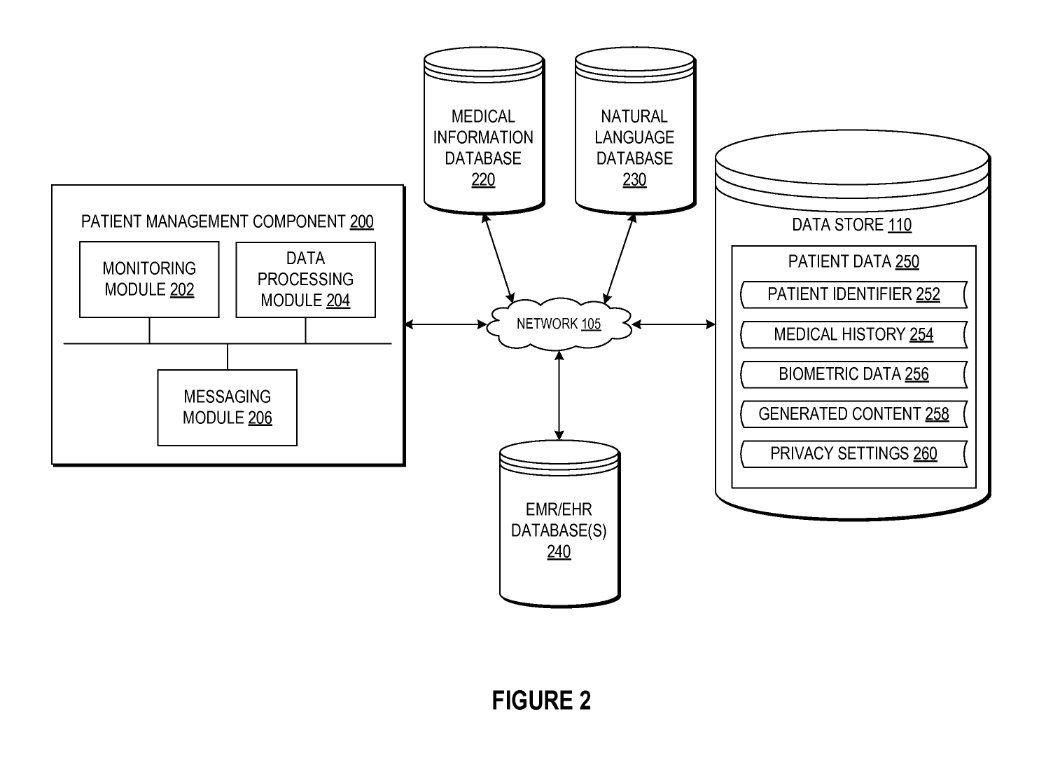

In one embodiment, the medical server 150 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to monitor patient data and manage medical alerts. In certain embodiments, the medical server 150 includes a patient management component 200. The functionality of the patient management component 200 and its various modules is described below with reference to FIG. 2.

The electronic record server 160 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to monitor patient data and manage medical alerts. In certain embodiments, one or more electronic record servers 160 may be associated with various medical entities, such as hospitals, clinics, laboratories, etc. The electronic records servers 160 may serve as Electronic Medical Record (EMR) and/or Electronic Health Record (EHR) systems that contain patient data accessible via their application program interfaces (APIs). The electronic record servers 160 may include, for example, lab reports and interaction visit records from hospitals and clinics, which may be retrieved by the medical server 150 and transmitted to a patient's care team as part of a medical alert message. In some embodiments, the medical server 150 may access and retrieve patient data stored on the electronic server 160. For example, the medical server 150 may be configured to utilize an API of the electronic record server 160.

Reference is now made to FIG. 2, which illustrates the various modules of the patient management component 200 and an illustrative patient data structure. Patient data 250 illustrates a data structure containing information that may be utilized in various embodiments described herein. For example, patient data 250 includes a patient identifier 252, medical history 254, biometric data 256, generated content 258, and privacy settings 260.

The patient identifier 252 may include one or more of a name of the patient, a social security number, a unique patient idea provided by the patient's healthcare provider, or any other suitable information for identifying the patient.

The medical history 254 may include information describing the patient's personal medical history such as past diagnoses, past surgical procedures, past/present medical conditions, and/or past/present drug prescriptions, as well as family medical history information. The medical history 254 may include medical data retrieved from one or more EMR/EHR databases 240 (e.g., which may be associated with one or more electronic record servers 160).

The biometric data 256 may include any biometric data captured by a wearable device (e.g., monitoring device 1250) of the patient, as well as any biometric data captured by other devices, such as biometric data monitored during any prior medical procedures or examinations.

The generated content 258 may include any video, images, or audio captured/recorded either by the patient (e.g., user-generated content) or by a member of the patient's care team. Such content may include, but is not limited to, an image of a part of the patient's body captured using a personal camera; medical images (e.g., ultrasounds, X-rays, etc.); video recorded during a medical procedure; video recorded by a patient's personal camera; a video of a doctor visit; audio recordings (e.g., a conversation with a member of the patient's care team, instructions from a doctor to the patient, a patient's verbal description of his/her symptoms, etc.); and messages transmitted between patient, care team, and caretaker (e.g., e-mails, SMS messages, etc.).

The privacy settings 260 may include any settings governing how the patient's data is to be managed. For example, the settings may be specified directly by the patient (e.g., using the patient device 120), by members of the patient's care team, specified to comply with a particular standard (e.g., HIPAA), or a combination thereof. Privacy settings may be used to govern which information, if any, is permitted to be shared with entities other than the patient's care team, such as caretakers or insurance providers. In some embodiments, the privacy settings 260 may govern which information stored in the EMR/EHR databases is accessible by the patient management component 200. In some embodiments, the privacy settings 260 may also include a preferred mode of communication for delivering messages to recipients (e.g., via e-mail, via SMS, etc.) which may be specified by the user and/or the recipients.

In one embodiment, the patient monitoring module 202 receives and organizes biometric data captured by one or more wearable devices of a patient. The patient monitoring module 202 may receive biometric data directly from a wearable device (e.g., monitoring device 125) or from a patient device (e.g., patient device 120) that is in communication with or operational control of the wearable device. In some embodiments, the monitoring module 202 may monitor the patient's biometric data in real-time. In other embodiments, the monitoring module 202 may receive biometric data at regular or irregular intervals. In other embodiments, the patient monitoring module 202 may receive biometric data only after the patient has approved the transmission of such data.

In one embodiment, the data processing module 204 processes medical alert notifications and associated data. In some embodiments, the data processing module 204 converts biometric data into a common format to facilitate its use across various devices. For example, biometric data may be translated into an mHealth compliant data format. In some embodiments, the data processing module 204 converts biometric data is it is received by the monitoring module 202. In other embodiments, the data processing module 204 converts the biometric data at a later time, such as when the data is to be sent to a device of a care team, which may serve to optimize processing efficiency. In some embodiments, the data processing module 204 may utilize an API of the electronic record server to access patient information (e.g., stored in the EMR/EHR database 240) and convert the data into a suitable format usable by the patient management component 200.

In some embodiments, the data processing module 204 may identify portions of patient data or biometric data that are relevant to a potential medical condition. For example, in some embodiments, the data processing module 204 may receive a “diagnosis code” from a device of the care team. The diagnosis code may represent a particular medical condition and/or a set of symptoms associated with a medical condition. The data processing module 204 may identify portions of patient data (e.g., stored as patient data 250, stored in the EMR/EHR databases 240, etc.) or biometric data that may be associated with the diagnosis code. For example, if the diagnosis code relates to a heart condition, the data processing module 204 may identify heart-related biometric data (e.g., a heart rate), which may be processed downstream into a message sent to the care team device. In some embodiments, the data processing module 204 may retrieve medical information related to the diagnosis code from a medical information database 220.

In some embodiments, the data processing module 204 may perform varying degrees of predictive analysis on data received from the patient or care team. For example, in some embodiments, the data processing module 204 may generate transcripts of audio conversations held between the patient and members of the care team or audio measures generated by a device of the patient (e.g., patient device 120). The data processing module 204 may retrieve data from a natural language database 230, which includes a database of words and phrases to facilitate extraction/identification of medically-relevant terms. The medically-relevant terms, for example, may be cross-referenced against terms in the medical information database 220 and/or utilized as input parameters to a symptom checking algorithm. The processing module 204 may provide the results to one or more devices of the care team in the form of a message to aid in the care team's decision-making process. In some embodiments, the results may be utilized to identify relevant biometric data to be sent to the care team so as to avoid sending unnecessarily large amounts of data for the care team to sift through.

In one embodiment, the messaging module 206 generates messages (e.g., e-mails, SMS messages, instant messages, etc.) to be sent to the patient, members of the care team, and one or more caretakers of the patient. The messages may include medical alerts, informational messages, appointment reminders, care team meeting reminders, or other messages. Messages may include attachments, such as images, video, audio, or biometric data.

In some embodiments, the messaging module 206 may determine to whom messages should be sent, which information is to be included, and which information to exclude based on the privacy settings 260. For example, the privacy settings 260 may indicate members of the care team to which medical alert messages should be sent, and may include an indication that some members of the care team may be authorized to receive varying amounts of data associated with the patient (e.g., the patient's primary care physician may receive data in an unrestricted fashion, while a technician may receive less information). The privacy settings 260 may also indicate other individuals that are unaffiliated with the care team but may be authorized to receive medical alert messages, while such messages may be significantly restricted in terms of the data that may be attached. For example, the privacy settings 260 may indicate that a caretaker of the patient may receive only a notification of an emergency with biometric data being restricted.

Although each of the data store 110, the patient device 120, the monitoring device 125, the care team device 130, the caretaker device 140, the medical server 150, and the electronic record server 160 are depicted in FIG. 1 as single, disparate components, these components may be implemented together in a single device or networked in various combinations of multiple different devices that operate together. In some embodiments, some or all of the functionality of the medical server 150 may be performed in conjunction with multiple devices (e.g., additional servers, client devices, etc.). For example, the patient device 120 may implement a software application that performs the functions of one or more of the monitoring module 202, the data processing module 204, or the messaging module 206. In some embodiments, one or more of the modules of the patient management component 200 may be hosted on or executed by different devices. Moreover, while the functionality of the patient management component 200 is described with respect to a single patient, the patient management component may support multiple patients and provide its functionality to each patient in a concurrent fashion.

### Medical Alert Management

The various devices depicted in FIG. 1 may utilize software to enable the generation of medical alerts, provide visualization of data, and facilitate messaging back and forth between patients and care team members. At the patient end, a patient device (e.g., patient device 120) may provide an input interface that varies depending on the nature of the patient's current or past medical conditions.

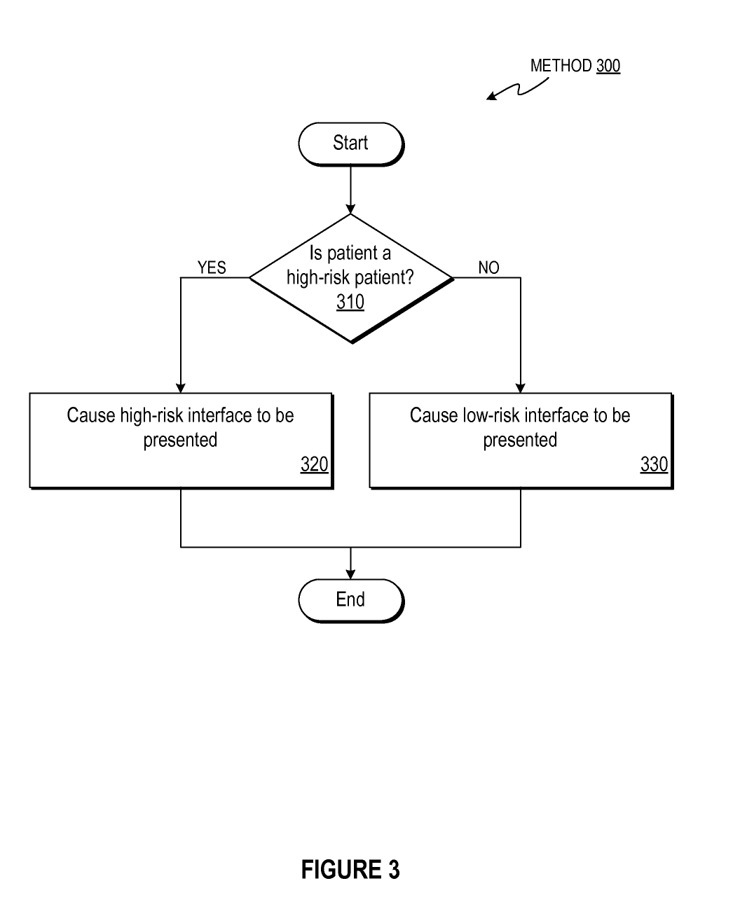

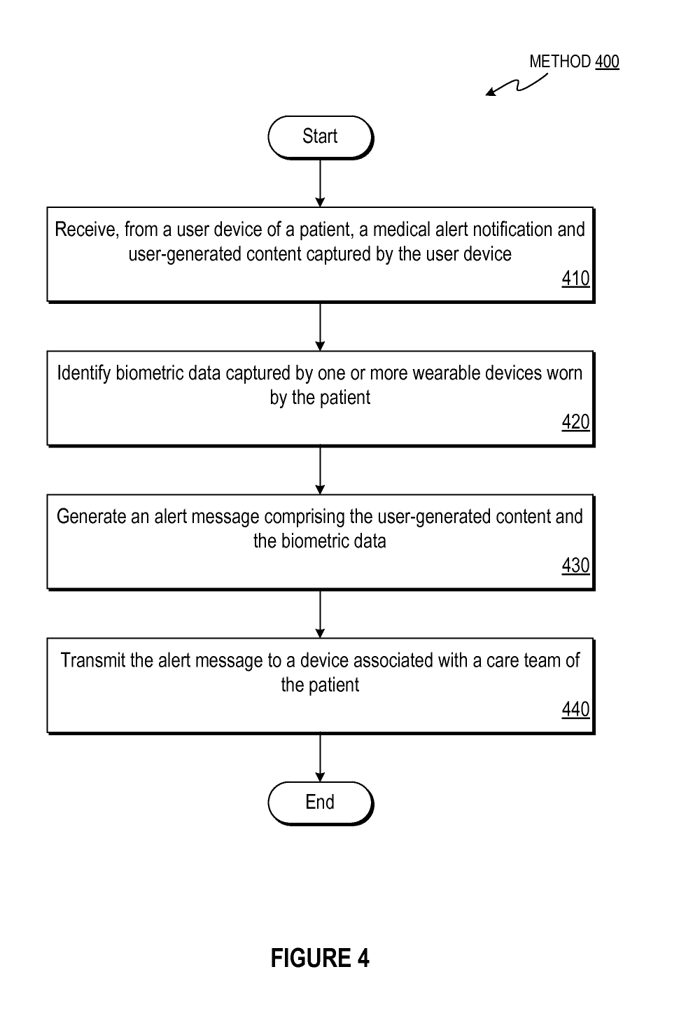

FIG. 3 is a flow diagram illustrating a method 300 for determining which type of user interface is to be presented on a client device in accordance with an embodiment of the disclosure. FIG. 4 is a flow diagram illustrating a method 400 for managing a medical alert in accordance with an embodiment of the disclosure. The methods 300 and 400 may each be performed by processing logic that includes hardware (e.g., circuitry, dedicated logic, programmable logic, microcode, etc.), software (e.g., instructions run on a processing device to perform hardware simulation), or a combination thereof. In some embodiments, the methods 300 and 400 are each performed by a processing device executing one or more of the monitoring module 202, the data processing module 204, or the messaging module 206 described with respect to FIG. 2. In one embodiment, the methods 300 and 400 are executed by a processing device of a server (e.g., the medical server 150). In another embodiment, the methods 300 and 400 are each performed by a processing device of a different device (e.g., the patient device 120, the care team device 130, etc.). Similarly, the method 400 may be performed, in some embodiments, by a processing device of a server (e.g., the medical server 150) or a processing device of a different device (e.g., the patient device 120, the care team device 130, etc.).

Referring now to FIG. 3, method 300 begins at block 310, where a processing device determines if a specific patient is a high-risk patient. In certain embodiments, a high-risk indicator may be included in the patient's records (e.g., stored in medical history 254). The high-risk indicator may be, for example, a flag that indicates whether the patient is or is not a high-risk patient. In other embodiments, the high-risk indicator may be score bounded by a minimum score and a maximum score, with its value being a function of various physical parameters.

In some embodiments, the high-risk indicator may be set by a member of the care team. For example, in reviewing the patient's medical history, a doctor may determine that there is a high likelihood of the patient having a medical emergency in which the patient needs to notify the care team quickly. The doctor may then update the high-risk indicator. In some embodiments, the patient may set the high-risk indicator if he/she believes a medical emergency is likely to occur.

In some embodiments, the high-risk indicator may be automatically set based on patient data. For example, the processing device may determine that the patient's biometric data satisfies a condition that may suggest the patient is in a high-risk state. For example, if the processing device detects that the patient's blood glucose level has dropped below a threshold amount, the processing device may set the high-risk indicator to indicate that the patient is currently in a high risk state. In some embodiments, if the wearable device worn by the patient includes an inertial measurement unit and a fall is detected (e.g., rapid acceleration or velocity in a downward direction), the processing device may set the high-risk indicator to indicate that the patient is currently in a high risk state (i.e., the patient may have sustained a fall).

If the processing device determines that the patient is a high-risk patient, then the method 300 proceeds to block 320, where the processing device causes a high-risk interface to be presented. For example, if the processing device is that of a medical server (e.g., medical server 150) or a care team device (e.g., care team device 130), the processing device may transmit a message to a patient device (e.g., patient device 120), which may, in response, present for display a high-risk interface (e.g., via the user interface 122) thereafter. As another example, if the processing device is that of a patient device (e.g., patient device 120), the patient device may present for display the high-risk interface without receiving a message from another device.

Reference is now made to FIG. 5A, which is an exemplary graphical user interface (GUI) window 500 illustrating features of a high-risk interface. The GUI window 500 includes a header region 502 (which may include a company logo or other graphics or indicators), a search field 504 (which may be used to search for contacts, messages, etc.), and a medical issue list 506.

The medical issue list 506 may include various medical issues that are currently being evaluated or treated by the patient's care team. In some embodiments, the medical issue list 506 may include medical issues related to one or more patients, such as family members sharing the same device/account. The medical issues may be generated by the patient, by the care team, or both, and may be edited and updated based on ongoing discussions or consultations with the care team. Medical issues may be dismissed by the care team if they are no longer relevant to the patient (e.g., if the medical issue was a fever, the medical issue may be removed from the medical issue list 506 once the fever and associated symptoms subside). An example medical issue 508 is shown, which includes information describing the issue (“Christine's Rash”), a name of the member of the care team responsible (“John Williams, MD”), an associated message or update (“Lab result is available now . . . ”), a patient portrait 510, and care team member portrait 512.

The GUI window 500 further includes messaging and content generation options. For example, button 516, button 518, and button 520 allow the user to record a voice message, record video or capture an image, and make an emergency call, respectively. Message button 522 allows the user to view or send paging notifications (“pings”), and additional options button 524 allows the user to view additional options of the software application. In some embodiments, the GUI window 500 may facilitate text-based chats between the patient and one or more members of the patient's care team.

The GUI window 500 further includes medical alert button 514, which is displayed prominently (e.g., in the form of a large red button) to aid the patient in generating a medical alert indication in case of an emergency. A selection of the medical alert button 514, in some embodiments, automatically transmits a medical alert notification to one or more devices of the care team, and may also provide the user with an option to transmit content in the form of a voice recording, image, or video. In some embodiments, the medical alert notification is not sent until a predetermined time has passed (e.g., 2 seconds) so as to avoid triggering a false alarm.

Referring once again to FIG. 3, if the processing device determines that the patient is not a high-risk patient, then the method 300 proceeds to block 330, where the processing device causes a low-risk interface to be presented. For example, if the processing device is that of a medical server (e.g., medical server 150) or a care team device (e.g., care team device 130), the processing device may transmit a message to a patient device (e.g., patient device 120), which may, in response, present for display a low-risk interface (e.g., via the user interface 122) thereafter. As another example, if the processing device is that of a patient device (e.g., patient device 120), the patient device may present for display the low-risk interface without receiving a message from another device.

Reference is now made to FIG. 5B, which is an exemplary GUI window 550 illustrating features of a low-risk interface. The GUI window 550 is similar to the GUI window 500 with the exception that the medical alert button 514 is absent. In some embodiments, the GUI window 550 has the same functionality as the GUI window 500, except with minor modifications to the layout.

Referring once again to FIG. 3, the processing device may perform method 300 periodically/continuously to assess the state of the patient and determine a suitable interface at any given time.

Referring now to FIG. 4, method 400 begins at block 410, where a processing device receives, from a user device of a patient (e.g., patient device 120), a medical alert notification and user-generated content captured by the user device. For example, the medical alert notification may be generated by a user device (e.g., patient device 120) in response to the patient selecting the medical alert button 514 in high-risk GUI window 500 described with respect to FIG. 5A. The patient may use the user device to capture user-generated content that is to be transmitted (e.g., to the medical server 150, to the care team device 130, etc.) along with the medical alert notification. In some embodiments, the user-generated content comprises one or more of a video, an image, or an audio recording captured by the user device.

Reference is now made to FIGS. 6A and 6B, which show exemplary GUI windows 600 and 650, respectively, illustrating voice messaging in accordance with an embodiment of the disclosure. In some embodiments, the GUI window 600 may be presented in response to the patient selecting the medical alert button 514 of the GUI window 500, as described with respect to FIG. 5A.

The GUI window 600 includes a header region 602 that includes a back button (which may be used to cancel the message and/or return to a previous screen). The GUI window 600 further includes a time indicator 606 to indicate the length of the voice message as it is being recorded. In some embodiments, the voice message may be restricted to a maximum duration (e.g., 10 minutes), which may be represented by a size of bar 608 (representing elapsed time) and a relative location of indicator 610 to an edge 612 of the GUI window 600. The message may also be sent or canceled in response to a selection of the send button 618 and cancel button 616, respectively. For example, selection of the send button 618 may provide the user with an opportunity to confirm sending the message, and may additionally allow the user to play it back prior to sending.

The GUI window 600 further includes medical alert button 614 which, upon selection by the patient, ends recording the message and transmit the message the message along with a medical alert notification (e.g., to the medical server 150, to the care team device 130, etc.). A selection of the medical alert button 614 may cause the GUI window 650 of FIG. 6B to be presented, which may show a progress indicator 620 to indicate that the message is being sent (e.g., uploaded to the medical server 150). The progress indicator 620, as illustrated, may gradually wrap around the medical alert button 301, forming a complete circle once the message has been sent. Shortly after the message has been sent, the GUI window 500 may be presented.

Referring once again to FIG. 4, at block 420, the processing device identifies biometric data (e.g., biometric data 256) captured by one or more wearable devices worn by the patient (e.g., monitoring device 125). In some embodiments, the one or more wearable devices comprise one or more of a glucose monitor, a blood pressure monitor, an electrocardiogram monitor, a respiratory monitor, a pulse oximeter, a temperature monitor, or other type of wearable monitoring device. In some embodiments, the one or more wearable devices include transdermal devices or subdermal devices. In some embodiments, the processing device converts the biometric data into a suitable data format, such as an mHealth compliant data format.

In some embodiments, the processing device identifies the biometric data by determining an identity of the patient based on information contained in the medical alert notification, identifying a record associated with the patient (e.g., matching the identity to patient identifier 252 of patient data 250), and retrieving biometric data associated with the record (e.g., biometric data 256). In some embodiments, in response to receiving the medical alert notification, the processing device identifies the biometric data by first transmitting an instruction to the one or more wearable devices to capture biometric data and/or transmit previously captured biometric data. Captured biometric data is then received by the processing device (e.g., the biometric data may be data captured in real-time, previously captured data, or a combination of both). In some embodiments, the processing device identifies biometric data by extracting the biometric data from a larger set of biometric data. The extracted biometric data may correspond to data captured by the one or more wearable devices within a predefined time (e.g., 5 minutes, 10 minutes, etc.) prior to receiving the medical alert notification.

In some embodiments, different types of biometric data may include identifying terms to facilitate diagnosis and analysis. For example, heart rate data may include one or more identifiers such as “chest”, “heart”, and “pulse”. In some embodiments, if the user-generated content comprises audio data (e.g., such as a voice or video recording), the processing device may extract textual data from the audio data (e.g., using the natural language database 230). The processing device may further identify one or more medically-relevant terms within the textual data. The processing device may further utilize the one or more medically-relevant terms to extract the biometric data from a larger set of biometric data. For example, if the processing device identified the medically-relevant term “chest pain”, the processing device may identify biometric data by matching the medically-relevant term to identifiers associated with the biometric data (e.g., “chest pain” may map to “chest”, and thus identify heart rate data as biometric data relevant to the patient's condition). Biometric data that does not match medically-relevant terms may be excluded (e.g., blood glucose data may be excluded when the patient is complaining about chest pain). In some embodiments, the processing device may identify time-related phrases, such as “10 minutes ago”, “today”, “yesterday”, etc. Time-related phrases may also be used in combination with or in lieu of medically-relevant terms to identify biometric data. For example, if the patient says, “I have been having chest pain for an hour,” the processing device may identify the terms “chest pain” and “hour”. The processing device may then identify biometric data corresponding to heart rate data and electrocardiogram data captured over the past hour or slightly longer (e.g., 1.5 hours to observe any changes from a stable condition), while excluding older and unrelated biometric data.

At block 430, the processing device generates an alert message comprising the user-generated content and the biometric data. The alert message may be, for example, an e-mail, an SMS message, an instant message, or any other suitable electronic message. The message may further comprise an identifier of the patient. At block 440, the processing device transmits the alert message to one or more devices associated with a care team (e.g., care team device 130).

Reference is now made to FIG. 7, which shows an exemplary GUI window 700 illustrating an interface that may be presented on a device of a member of a care team in accordance with an embodiment of the disclosure. The GUI window 700 includes a header region 702 (which may include a company logo or other graphics or indicators), a search field 704 (which may be used to search for contacts, messages, etc.), a message list 706, and additional application options 714.

The message list 706 may include medical issues for patients receiving healthcare services from the care team, as well as messages from patients and other members of the care team. An example message 708 corresponding to a medical alert message is shown. The message 708 includes a name of the patient (“Matthew Williams), a gender and age of the patient (“M 70y”), an indication of attached user-generated content (“Voice Message”), and a patient portrait 710. The message 708 may also include an indicator 712 to indicate to the care team member that the message is a medical alert. In some embodiments, other indicators may be used to indicate urgency, such as a colored border around the message 708, an animation, etc.

### Generation and Dispatch of Medical Alert Messages

Medical alert messages that include sensitive patient information may be subject to privacy settings. The privacy settings may be less restrictive in messages sent to members of the patient's care team and more restrictive in messages sent to other entities.

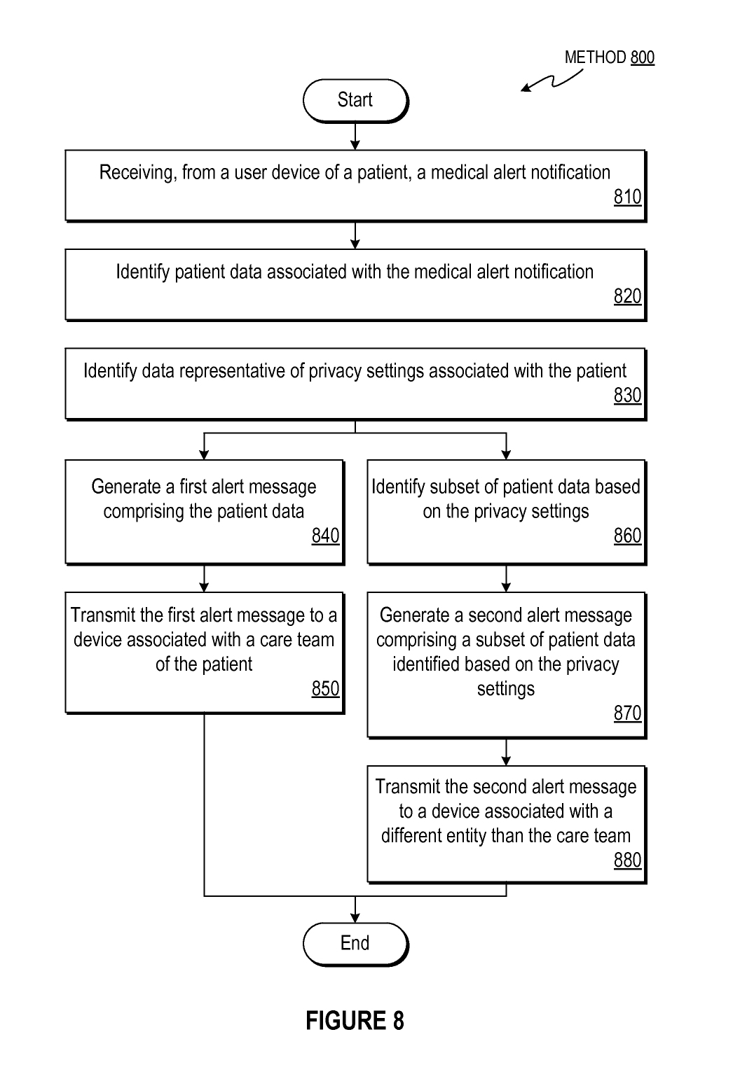

FIG. 8 is a flow diagram illustrating a method 800 for transmitting messages to multiple entities in accordance with an embodiment of the disclosure. The method 800 may be performed by processing logic that includes hardware (e.g., circuitry, dedicated logic, programmable logic, microcode, etc.), software (e.g., instructions run on a processing device to perform hardware simulation), or a combination thereof. In one embodiment, the method 800 may be performed by a processing device executing one or more of the monitoring module 202, the data processing module 204, or the messaging module 206 described with respect to FIG. 2. In one embodiment, the method 800 is executed by a processing device of a server (e.g., the medical server 150).

Referring to FIG. 8, method 800 begins at block 810, where processing device receives, from a user device of a patient (e.g., patient device 120), a medical alert notification. Block 810 may be performed in a similar fashion as described with respect to block 410 above.

At block 820, the processing device identifies patient data associated with the medical alert notification. In some embodiments, the processing device identifies the patient data by determining an identity of the patient based on information contained in the medical alert notification and identifying a record associated with the patient (e.g., matching the identity to patient identifier 252 of patient data 250, identifying patient data within the EMR/EHR databases 240, etc.).

At block 830, the processing device identifies data representative of privacy settings associated with the patient (e.g., privacy settings 260). The privacy settings may include, for example, settings governing the management of the patient's data private data. In some embodiments, the settings may be specified directly by the patient (e.g., using the patient device 120), by members of the patient's care team, specified to comply with a particular standard (e.g., HIPAA), or a combination thereof.

At block 840, the processing device generates a first alert message comprising the patient data. The first alert message may be a message to be sent to one or more devices of the patient's care team. In some embodiments, the processing device may determine that there are no restrictions on patient data, based on the privacy settings, when being sent to the patient's care team. In other embodiments, the processing device may determine that some devices of the care team may have restricted access to some patient data, based on the privacy settings, and avoids sending such information. At block 850, the processing device transmits the first alert message to one or more devices associated with a care team of the patient. Blocks 840 and 850 may be performed in a similar manner as described with respect to blocks 430 and 430, respectively, above.

In some embodiments, one or more of blocks 860, 870, or 880 may be performed before, after, or concurrently with one or more of blocks 840 or 850. At block 860, the processing device identifies a subset of patient data based on the privacy settings. The processing device may determine that an alert message is to be transmitted to a different entity than the care team based on the patient's preferences. Accordingly, the processing device may identify a subset of patient data that includes information that the entity is authorized to receive.

At block 870, the processing device generates a second alert message comprising a subset of patient data identified based on the privacy settings. At block 880, the processing device transmits the second alert message to one or more devices associated with a different entity than the care team. For example, the different entity may correspond to, for example, one or more caretakers of the patient (e.g., family members, friends, etc.). As another example, the different entity may correspond to an insurance provider. In some embodiments, the patient may request full or nearly-full access to his/her personal information, and may also permit an entity to control which information it receives in response to a medical alert notification.

### Selective Monitoring of Biometric Data

In some situations, it is beneficial for a doctor to identify and pre-empt a potential medical issue before the patient is aware of it. The doctor may selectively monitor specific biometric data based on the patient's medical history and/or a current or prior conversation held with the patient. The doctor may use a symptom checking algorithm to attempt to identify a potential medical issue and possibly formulate a diagnosis. The doctor may also rely on predictive intelligence to identify a potential medical issue or at least identify and present data to the doctor to facilitate his/her analysis.

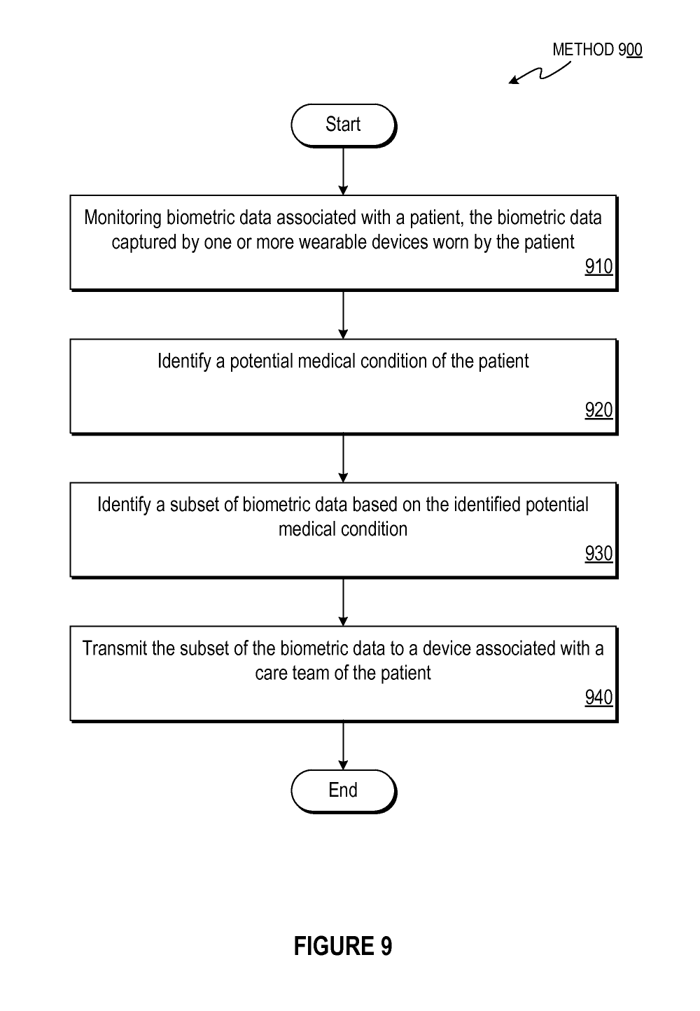

FIG. 9 is a flow diagram illustrating a method 900 for selectively monitoring biometric data of a patient in accordance with an embodiment of the disclosure. The method 900 may be performed by processing logic that includes hardware (e.g., circuitry, dedicated logic, programmable logic, microcode, etc.), software (e.g., instructions run on a processing device to perform hardware simulation), or a combination thereof. In one embodiment, the method 900 may be performed by a processing device executing one or more of the monitoring module 202, the data processing module 204, or the messaging module 206 described with respect to FIG. 2. In one embodiment, the method 800 is executed by a processing device of a server (e.g., the medical server 150).

Referring now to FIG. 9, the method 900 begins at block 910, where a processing device monitors biometric data associated with a patient, with the biometric data having been captured by one or more wearable devices worn by the patient.

At block 920, the processing device identifies a potential medical condition of the patient. In some embodiments, the processing device may identify the potential medical condition in response to determining that the monitored biometric data has satisfied a threshold condition. For example, the processing device may determine that the patient's blood glucose level dropping below threshold amount represents a potential medical issue. In some embodiments, the threshold condition may be specified by the care team. In some embodiments, the threshold condition may be specified by a different source (e.g., the medical information database 220).

In some embodiments, the potential medical condition may be specified by a member of the care team (e.g., a diagnosis code). The diagnosis code may be a medical term, a number, or any unique identifier of a medical condition. In some embodiments, the diagnosis code may be specified by the doctor during a conversation with the patient. For example, the processing device may extract text from audio data of the conversation and identify a diagnosis code. In some embodiments, the processing device may index the conversation in real-time based on identified medically-relevant terms (e.g., as described with respect to block 420 above). In some embodiments, the processing device may index previous conversations and medical history data.

In some embodiments, the processing device may identify the potential medical condition in response to receiving a medical alert notification from a patient device (e.g., patient device 120). For example, the potential medical condition may be identified in a similar manner described with respect to block 420 above (e.g., extracting medically-relevant terms).

In some embodiments, the processing device may identify the potential medical condition as a fall in response to gyroscopic data collected by an inertial measurement unit of the patient device or wearable device that indicates the user may have fallen.

At block 930, the processing device identifies a subset of biometric data based on the identified potential medical condition. For example, the potential medical condition may be an identifier (e.g., a medically-relevant term) that the processing device may use to identify biometric data that are relevant to the potential medical condition while excluding biometric data that is not relevant.

In some embodiments, the processing device may extract terms spoken by a member of the care team (e.g., during a conversation with the patient or as a voice command for the application running on the care team member's device). For example, a doctor may say, “I would like to see the patient's blood pressure over the last five hours.” The processing device may extract the terms “blood pressure” and “five hours”. The term “five hours” may be interpreted to mean within the past five hours. As a result, the processing device may identify blood pressure data measured over the past five hours (i.e., as a subset of biometric data), which may be subsequently transmitted to the doctor's device for visualization and analysis.

In some embodiments, if the potential medical condition was determined by the processing device to be a fall, the processing device may identify biometric data relevant to a fall (e.g., blood glucose data, breathing rate data, heart rate data, etc.) as the subset of biometric data.

At block 940, the processing device transmits the subset of the biometric data to one or more devices associated with a care team of the patient. In some embodiments, the processing device may also generate a medical alert message depending on how the potential medical condition was identified. For example, if the processing device determines that the biometric data satisfies a threshold condition, a medical alert message may be generated even without the patient using his/her device to generate a medical alert indication. As another example, the medical alert message may be generated in response to the processing device detecting a fall. The medical alert message may be sent before, after, or concurrently with the subset of the biometric data. In some embodiments, the medical alert message includes the subset of the biometric data.

### General System Embodiments

For simplicity of explanation, the methods of the present disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture”, as used herein, is intended to encompass a computer program accessible from any computer-readable device or storage media.

FIG. 10 illustrates a diagrammatic representation of a machine in the exemplary form of a computer system 1000 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 1000 may be utilized by or illustrative of any of the data store 110, the patient device 120, the monitoring device 125, the care team device 130, the caretaker device 140, or the medical server 150.

The exemplary computer system 1000 includes a processing device (processor) 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage device 1020, which communicate with each other via a bus 1010.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 for performing the operations and steps discussed herein.

The computer system 1000 may further include a network interface device 1008. The computer system 1000 also may include a video display unit 1012 (e.g., a liquid crystal display (LCD), a cathode ray tube (CRT), or a touch screen), an alphanumeric input device 1014 (e.g., a keyboard), a cursor control device 1016 (e.g., a mouse), and a signal generation device 1022 (e.g., a speaker).

Power device 1018 may monitor a power level of a battery used to power the computer system 1000 or one or more of its components. The power device 1018 may provide one or more interfaces to provide an indication of a power level, a time window remaining prior to shutdown of computer system 1000 or one or more of its components, a power consumption rate, an indicator of whether computer system is utilizing an external power source or battery power, and other power related information. In some embodiments, indications related to the power device 1018 may be accessible remotely (e.g., accessible to a remote back-up management module via a network connection). In some embodiments, a battery utilized by the power device 1018 may be an uninterruptable power supply (UPS) local to or remote from computer system 1000. In such embodiments, the power device 1018 may provide information about a power level of the UPS.

The data storage device 1020 may include a computer-readable storage medium 1024 on which is stored one or more sets of instructions 1026 (e.g., software) embodying any one or more of the methodologies or functions described herein. The instructions 1026 may also reside, completely or at least partially, within the main memory 1004 and/or within the processor 1002 during execution thereof by the computer system 1000, the main memory 1004 and the processor 1002 also constituting computer-readable storage media. The instructions 1026 may further be transmitted or received over a network 1030 (e.g., the network 105) via the network interface device 1008.

In one embodiment, the instructions 1026 include instructions for one or more components/modules (e.g., the patient management component 200) which may correspond to any of the components/modules described with respect to FIG. 2. While the computer-readable storage medium 1024 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “receiving”, “retrieving”, “transmitting”, “computing”, “generating”, “detecting”, “performing”, “analyzing”, “determining”, “enabling”, “identifying”, “modifying”, “aggregating”, “storing”, “rendering”, “converting”, “extracting”, “presenting”, “filtering”, “updating”, “including”, “excluding”, “displaying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein or by way of illustration in the accompanying drawings. Indeed, other various embodiments of and modifications to the present disclosure pertaining to management of medical alerts, in addition to those described herein, will be apparent to those of ordinary skill in the art from the preceding description and accompanying drawings. Thus, such other embodiments and modifications pertaining to management of medical alerts are intended to fall within the scope of the present disclosure. Further, although the present disclosure has been described herein in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A method comprising:
receiving, from a user device of a patient, a medical alert notification and user-generated content captured by the user device;
identifying biometric data captured by one or more wearable devices worn by the patient;
generating a first alert message comprising the user-generated content and the biometric data; and
transmitting the alert message to a device associated with a care team of the patient.

2. The method of claim 1, wherein the user-generated content comprises audio data, the method further comprising:
extracting textual data from the audio data; and
identifying one or more medically-relevant terms within the textual data, wherein identifying the biometric data comprises extracting the biometric data from a larger set of biometric data based on the one or more medically-relevant terms.

3. The method of claim 1, wherein identifying biometric data comprises extracting the biometric data from a larger set of biometric data, and wherein the extracted biometric data corresponds to data captured by the one or more wearable devices within a predefined time prior to receiving the medical alert notification.

4. The method of claim 1, wherein the biometric data is captured in response to receiving the medical alert notification.

5. The method of claim 1, further comprising:
generating a second alert message comprising a subset of data included in the first alert message; and
transmitting the second alert message to a device associated with a caretaker of the patient.

6. The method of claim 5, wherein generating the second alert message comprises identifying the subset of data based on privacy settings associated with the patient.

7. The method of claim 1, further comprising:
receiving, from the device associated with the care team, an identifier of a potential medical condition of the patient;
identifying a subset of the biometric data based on the identifier of the potential medical condition; and
transmitting the subset of the biometric data to the device associated with the care team.

8. The method of claim 1, further comprising:
converting the biometric data into an mHealth compliant data format.

9. The method of claim 1, wherein the one or more wearable devices comprise one or more of a glucose monitor, a blood pressure monitor, an electrocardiogram monitor, a respiratory monitor, a pulse oximeter, or a temperature monitor.

10. The method of claim 1, wherein the user-generated content comprises one or more of a video, an image, or an audio recording captured by the user device.

11. A system comprising:
a memory;
a processing device communicatively coupled to the memory, wherein the processing device is configured to:
receive, from a user device of a patient, a medical alert notification and user-generated content captured by the user device;
store the medical alert notification and the user-generated content in the memory;
identify, within the memory, biometric data captured by one or more wearable devices worn by the patient;
generate a first alert message comprising the user-generated content and the biometric data; and
transmit the alert message to a device associated with a care team of the patient.

12. The system of claim 11, wherein the user-generated content comprises audio data, and wherein the processing device is further configured to:
extract textual data from the audio data;
store the textual data in the memory; and
identify one or more medically-relevant terms within the textual data, wherein to identify the biometric data, the processing device is further configured to extract the biometric data from a larger set of biometric data based on the one or more medically-relevant terms.

13. The system of claim 11, wherein to identify the biometric data, the processing device is further configured to extract the biometric data from a larger set of biometric data, and wherein the extracted biometric data corresponds to data captured by the one or more wearable devices within a predefined time prior to receiving the medical alert notification.

14. The system of claim 11, wherein the biometric data is captured in response to receiving the medical alert notification.

15. The system of claim 11, wherein the processing device is further configured to:
generate a second alert message comprising a subset of data included in the first alert message; and
transmit the second alert message to a device associated with a caretaker of the patient.

16. The system of claim 15, wherein to generate the second alert message, the processing device is further configured to identify the subset of data based on privacy settings associated with the patient.

17. The system of claim 11, wherein the processing device is further configured to:
receive, from the device associated with the care team, an identifier of a potential medical condition of the patient;
identify a subset of the biometric data based on the identifier of the potential medical condition; and
transmit the subset of the biometric data to the device associated with the care team.

18. The system of claim 11, wherein the processing device is further configured to:
convert the biometric data into an mHealth compliant data format.

19. The system of claim 11, wherein the one or more wearable devices comprise one or more of a glucose monitor, a blood pressure monitor, an electrocardiogram monitor, a respiratory monitor, a pulse oximeter, or a temperature monitor, and wherein the user-generated content comprises one or more of a video, an image, or an audio recording captured by the user device.

20. A non-transitory, computer-readable storage medium having instructions encoded thereon that, when executed by a processing device, cause the processing device to:
receive, from a user device of a patient, a medical alert notification and user-generated content captured by the user device;
identify biometric data captured by one or more wearable devices worn by the patient;
generate a first alert message comprising the user-generated content and the biometric data; and
transmit the alert message to a device associated with a care team of the patient.
